(19) United States
(12) Patent Application Publication
(10) Pub. No.: US 2026/0236782 A1
(43) Pub. Date: Aug. 13, 2026

(54) INFORMATION PROCESSING DEVICE, INFORMATION PROCESSING SYSTEM, INFORMATION PROCESSING METHOD, AND RECORDING MEDIUM

(71) Applicant: Preferred Networks, Inc., Tokyo (JP)

(72) Inventors: Shotaro SANO, Tokyo (JP); Toshihiko YANASE, Tokyo (JP); Shuji SUZUKI, Tokyo (JP)

(21) Appl. No.: 19/637,384

(22) Filed: Apr. 2, 2026

Related U.S. Application Data
(63) Continuation of application No. PCT/JP2024/035271, filed on Oct. 2, 2024.

(30) Foreign Application Priority Data
Oct. 4, 2023 (JP) 2023-172466

(51) Int. Cl. G06N 3/0895; G06N 3/0475

(52) U.S. Cl. CPC G06N 3/0895; G06N 3/0475

(57) ABSTRACT

An information processing device includes one or more processors; and one or more memories storing instructions that, when executed by the one or more processors, cause the one or more processors to obtain one or more evaluation results of one or more first templates, the one or more first templates being used for generating one or more pieces of first input information to a first generative model; generate second input information to a second generative model based on the one or more evaluation results; and obtain a second template generated by inputting the second input information into the second generative model. The second input information includes at least one or more pieces of template information obtained based on the one or more evaluation results; and information related to one or more placeholders.

### CROSS-REFERENCE TO RELATED APPLICATIONS

This application is a continuation application of International Application No. PCT/JP2024/035271 filed on Oct. 2, 2024, and designating the U.S., which is based upon and claims priority to Japanese Patent Application No. 2023-172466 filed on Oct. 4, 2023, the entire contents of which are incorporated herein by reference.

### BACKGROUND

### 1. Technical Field

The present disclosure relates to an information processing device, an information processing system, an information processing method, and a program.

### 2. Description of the Related Art

Generative models, such as large language models (LLMs), are known. A generative model is a machine learning model configured to perform a predetermined task in accordance with input information, which is called a prompt, and output resultantly generated data. In order to obtain a desired output result from a generative model, a technique for optimizing a prompt has been proposed.

A template engine is used to generate a prompt input into a generative model. The template engine is a program configured to generate text data based on input data, using a predefined template.

### RELATED ART DOCUMENT

### Non-patent Document

Non-Patent Document 1: Yongchao Zhou, Andrei Ioan Muresanu, Ziwen Han, Keiran Paster, Silviu Pitis, Harris Chan, Jimmy Ba, “Large Language Models Are Human-Level Prompt Engineers”, Retrieved on Sep. 1, 2023

### SUMMARY

According to one aspect of the present disclosure, an information processing device includes one or more processors; and one or more memories storing instructions that, when executed by the one or more processors, cause the one or more processors to obtain one or more evaluation results of one or more first templates, the one or more first templates being used for generating one or more pieces of first input information to a first generative model; generate second input information to a second generative model based on the one or more evaluation results; and obtain a second template generated by inputting the second input information into the second generative model. The second input information includes at least one or more pieces of template information obtained based on the one or more evaluation results; and information related to one or more placeholders.

### BRIEF DESCRIPTION OF THE DRAWINGS

FIG. 1 is a block diagram illustrating an example of an overall configuration of an information processing system;

FIG. 2 is a block diagram illustrating an example of a functional configuration of an optimization device according to a first embodiment;

FIG. 3 is a diagram illustrating a first example of a template for a rewrite prompt;

FIG. 4 is a diagram illustrating an example of a template for an initial generation prompt;

FIG. 5 is a diagram illustrating an example of the initial generation prompt;

FIG. 6 is a diagram illustrating an example of an initial template;

FIG. 7 is a block diagram illustrating an example of a functional configuration of an execution device;

FIG. 8 is a flowchart illustrating an example of optimization process in the first embodiment;

FIG. 9 is a flowchart illustrating an example of an evaluation process;

FIG. 10 is a flowchart illustrating an example of a rewriting process;

FIG. 11 is a flowchart illustrating an example of an execution process;

FIG. 12 is a diagram illustrating a second example of the template for the rewrite prompt;

FIG. 13 is a block diagram illustrating an example of a functional configuration of an optimization device in Modified Example 1;

FIG. 14 is a diagram illustrating an example of a template for a prompt in Modified Example 2;

FIG. 15 is a diagram illustrating an example of a feedback information input field;

FIG. 16 is a diagram illustrating an example of an evaluation value input field;

FIG. 17 is a block diagram illustrating an example of a functional configuration of an optimization device according to a second embodiment;

FIG. 18 is a flowchart illustrating an example of an additional learning process according to the second embodiment; and

FIG. 19 is a block diagram illustrating an example of a hardware configuration of a computer.

### DETAILED DESCRIPTION

Hereinafter, embodiments of the present disclosure will be described with reference to the accompanying drawings. Here, in the present specification and the accompanying drawings, components having substantially the same functional configuration are denoted by the same reference numerals and duplicated descriptions thereof will be omitted.

### First Embodiment

A first embodiment of the present disclosure is an information processing system configured to generate various data based on a generative model. The information processing system in the present embodiment has a function of optimizing input information to be input into the generative model. In the present embodiment, the generative model may be, for example, a large language model (LLM). The generative model is not limited to the large language model, and may be a model configured to generate other data such as a voice or an image, or may be a base model.

It is known that an output result of the generative model varies depending on the content of the prompt. It is known that a prompt for obtaining a desired output result from the generative model varies depending on a type of the generative model and a task to be performed by the generative model. In order to obtain a desired output result from the generative model, a technique for optimizing the prompt is proposed. This type of technique is referred to as prompt engineering or the like.

In the related art, prompt engineering has been performed by experts by trial and error. That is, in the prompt engineering, the following process has been repeatedly performed until a desired output result is obtained: obtaining an output result when a prompt is input into a generative model, an expert rewriting the prompt based on the output result, and obtaining an output result when the rewritten prompt is input into the generative model. With respect to the above, a technique for automatically optimizing a prompt is proposed. This type of technique automatically performs prompt rewriting performed by experts by trial and error, according to a predetermined algorithm.

In the prompt engineering, attention has been paid to how to instruct a generative model to perform a desired task. In the present embodiment, a generative model is caused to perform a desired task by optimizing a structure of the prompt without changing the meaning of the instruction.

For example, an instruction such as “The following is a combination of an instruction describing a task and an input providing context. Write a response that appropriately satisfies the requirements” can be used. For example, the instruction can be described in the following three formats (1)-(3). The instructions exemplified blow all have the same semantic content, but differ in a document structure (specifically, symbols for headings).
(1) “Instruction: The following is a combination of an instruction describing a task and an input providing context. Write a response that appropriately satisfies the requirements.”
(2) “[Instruction] The following is a combination of an instruction describing a task and an input providing context. Write a response that appropriately satisfies the requirements.”
(3) “##Instruction
   The following is a combination of an instruction describing a task and an input providing context. Write a response that appropriately satisfies the requirements.”

Various formats can be used for describing a prompt, but it is not obvious which format should be used to describe the prompt to obtain a desired output. Additionally, depending on the type of the generative model and the content of the task, the format that yields a desired output result may vary.

As another example, there may be a prompt that includes a question sentence and answer options and instructs a choice of a correct option. This prompt includes contents of “a question sentence” and “options”, but it is not obvious in which order these contents should be described to improve the correct answer rate. For example, considering whether the order of “a question sentence”->“options” is better or the order of “options”->“a question sentence” is better, even if the former is more natural for a human being, it is not obvious which would result in a desired result output from the generative model.

A template engine is used to generate a prompt to be input into a generative model. The template engine is a program configured to generate text data based on input data, using a predefined template. The template engine is sometimes used to generate, for example, a web page, a source code, and the like. By using the template engine, a user can efficiently generate a complicated prompt.

The present embodiment optimizes the template for generating the input information to the generative model, thereby optimizing the input information to the generative model. In the present embodiment, evaluating the template based on the generative model and rewiring the template based on the evaluation result are repeatedly performed. In the rewriting of the template, the structure of the template is changed so as to maintain the semantic content of the input information. In one aspect, according to the present embodiment, a desired output result can be obtained from the generative model without changing the semantic content of the input information.

### Overall Configuration of Information Processing System

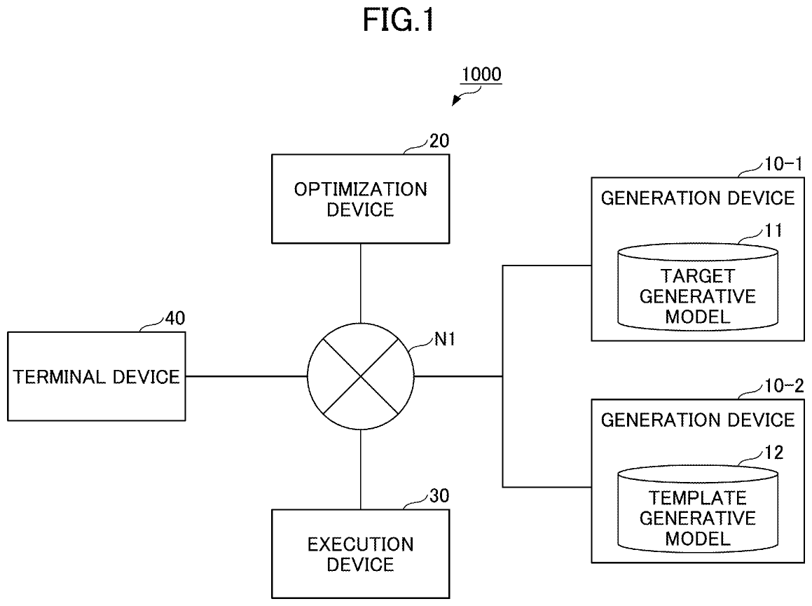

An overall configuration of the information processing system in the present embodiment will be described with reference to FIG. 1. FIG. 1 is a block diagram illustrating an example of the overall configuration of the information processing system.

As illustrated in FIG. 1, an information processing system 1000 includes two generation devices 10 (10-1 and 10-2), an optimization device 20, an execution device 30, and a terminal device 40. The generation devices 10, the optimization device 20, the execution device 30, and the terminal device 40 may be connected to each other via a communication network, such as a local area network (LAN) or the Internet, so as to enable data communication.

Hereinafter, when the generation devices 10 are distinguished from each other, they will be denoted using branch numbers, such as “generation device 10-1”, “generation device 10-2”, and the like. When the term “generation device 10” is simply used, it applies to all the generation devices 10.

The generation devices 10 are information processing devices, such as a personal computer, a workstation, a server, and the like configured to perform a predetermined task, using a generative model. One generation device 10-1 may include a target generative model 11. The other generation device 10-2 may include a template generative model 12.

The target generative model 11 is a generative model configured to perform the predetermined task. The template generative model 12 is a generative model configured to perform a task of generating a template. The target generative model 11 and the template generative model 12 may be, for example, a large-scale language model.

The target generative model 11 and the template generative model 12 may be realized by a single generative model. The target generative model 11 and the template generative model 12 may be the same generative model. The target generative model 11 and the template generative model 12 may share a portion of parameters. Additionally, for example, the target generative model 11 or the template generative model 12 may be realized by cooperating a plurality of generative models. The target generative model 11 or the template generative model 12 may include a plurality of generative models corresponding to tasks to be performed.

The optimization device 20 is an information processing device, such as a personal computer, a workstation, or a server, configured to optimize a template. The template optimized by the optimization device 20 is a template for generating input information to the target generative model 11.

The optimization device 20 may evaluate the template based on the target generative model 11. The optimization device 20 may optimize the template by rewriting the template based on the evaluation result of the template. The optimization device 20 may select a template (hereinafter also referred to as a “parent template”) to be rewritten, based on the evaluation result of the template. The optimization device 20 may generate a rewritten template (hereinafter also referred to as a “child template”) by rewriting the parent template based on the template generative model 12.

The optimization device 20 may repeatedly perform evaluating the template based on the target generative model 11 and rewriting the template based on the template generative model 12. The optimization device 20 may continue the repeated process until a predetermined condition is satisfied. The optimization device 20 may output the template at the time when the predetermined condition is satisfied as an optimized template.

The execution device 30 is an information processing device, such as a personal computer, a workstation, or a server, configured to instruct the generation device 10-1 to perform the predetermined task in response to a request from the terminal device 40. The execution device 30 stores the optimized template output by the optimization device 20, and may generate input information to the target generative model 11 based on the input data input by the terminal device 40 and the optimized template. The execution device 30 may obtain an output result when the generated input information is input into the target generative model 11.

The input information may include text data, image data, or audio data. The text data may be, for example, a natural language sentence called a prompt. The image data may be, for example, a still image or a moving image. The image data may include, for example, a captured image of a user. The audio data may include, for example, a voice spoken by a user. The input information may include a result of recognizing the image data or the audio data.

The terminal device 40 is an information processing terminal, such as a personal computer, a smartphone, or a tablet terminal, operated by a user of the information processing system 1000. The terminal device 40 may transmit an execution request of the predetermined task to the execution device 30. The execution request may include input data input by the user. The terminal device 40 may receive an output result of the target generative model 11 from the execution device 30 and present it to the user. The terminal device 40 may display the output result on a display device of the terminal device 40, for example. The terminal device 40 may emit a voice synthesized with the output result from a speaker of the terminal device 40, for example.

Here, the overall configuration of the information processing system 1000 illustrated in FIG. 1 is an example, and there may be various system configuration examples according to applications and purposes. The information processing system 1000 may be configured by one or more devices. The device included in the information processing system 1000 may be a system configured by a plurality of devices. Each of the functions included in the information processing system 1000 may be implemented by any device configuring the system. Each of the components included in the information processing system 1000 may be included in any device configuring the system.

The target generative model 11 and the template generative model 12 may be incorporated in a single generation device 10. The target generative model 11 or the template generative model 12 may be incorporated in the optimization device 20 or the execution device 30. The target generative model 11 or the template generative model 12 may be distributed and held in an external information processing system including a plurality of devices. In this case, the information processing system 1000 need not include the generation device 10.

One or more of the generation device 10, the optimization device 20, the execution device 30, and the terminal device 40 may be included in the information processing system 1000. The generation device 10, the optimization device 20, or the execution device 30 may be realized by a plurality of computers or may be realized as a cloud computing service. Two or more of the generation device 10, the optimization device 20, and the execution device 30 may be realized by stand-alone computers. The information processing system 1000 may be realized by a single device having the functions of the generation device 10, the optimization device 20, and the execution device 30, and the terminal device 40. The classification of devices such as the generation device 10, the optimization device 20, the execution device 30, and the terminal device 40 illustrated in FIG. 1 is an example.

### Functional Configuration of Optimization Device

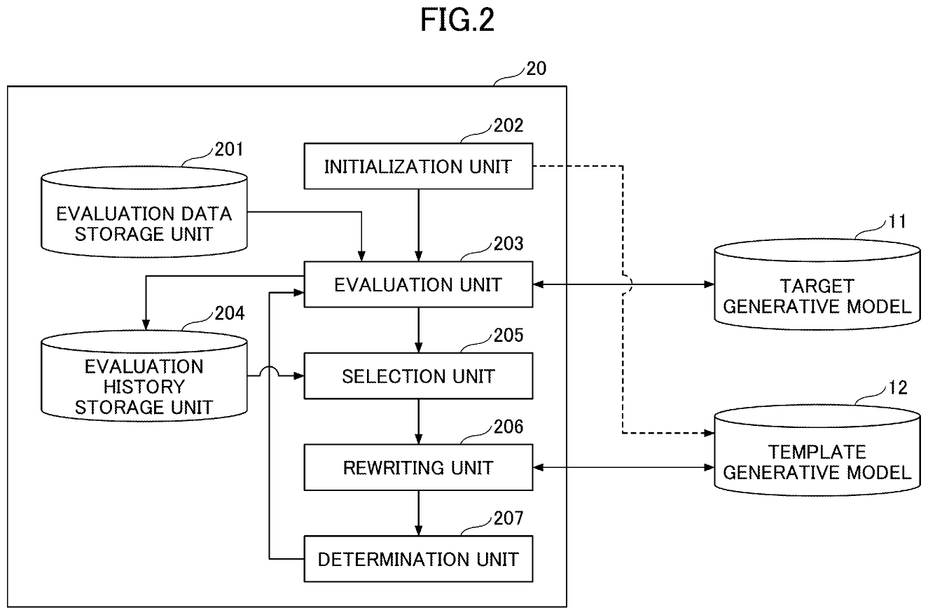

A functional configuration of the optimization device 20 will be described with reference to FIG. 2. FIG. 2 is a block diagram illustrating an example of the functional configuration of the optimization device according to the first embodiment.

As illustrated in FIG. 2, the optimization device 20 includes an evaluation data storage unit 201, an initialization unit 202, an evaluation unit 203, an evaluation history storage unit 204, a selection unit 205, a rewriting unit 206, and a determination unit 207. The optimization device 20 functions as the evaluation data storage unit 201, the initialization unit 202, the evaluation unit 203, the evaluation history storage unit 204, the selection unit 205, the rewriting unit 206, and the determination unit 207 by executing an optimization program installed in advance.

The evaluation data storage unit 201 stores, in advance, evaluation data used for evaluating the template. The evaluation data may be question-and-answer data, for example. The question-and-answer data may be data in which a question sentence, answer options, and a correct option are associated with one another. The question-and-answer data may be stored in a database in which items and values are associated with each other. As a method for associating items and values, for example, items and values may be stored as one set, information enabling acquisition of the other information from one information may be stored, or identification information of one information and the other information may be stored as one set.

As another example, the evaluation data may be natural language inference data or calculation data. The natural language inference data may be data indicating a relationship between two or more sentences (for example, implication and the like). The calculation data may be data indicating a calculation formula and a correct answer (for example, 1+2=3 and the like).

When the target generative model 11 is a generative model with speech recognition, the evaluation data may be data in which speech data indicating a question sentence is associated with text data indicating a correct answer. When the target generative model 11 is a generative model configured to generate an image, the evaluation data may be data in which image data indicating an image is associated with an evaluation value obtained by evaluating the image by a human.

The evaluation data may satisfy the following conditions, for example. The first condition is that the evaluation data is described so as to be interpretable by the target generative model 11 and the template generative model 12. The second condition is that the evaluation data has contents or quantities that can be estimated by the target generative model 11 and the template generative model 12.

The initialization unit 202 acquires one or more initial templates. The initial template is a template in an initial state before optimization. The initialization unit 202 may accept an input of an initial template designated by a user. The initialization unit 202 may generate an initial template based on the evaluation data read from the evaluation data storage unit 201.

When generating the initial template, the initialization unit 202 may generate the initial template by using the template generative model 12, for example. Specifically, first, the initialization unit 202 generates input information instructing the generation of the template and transmits it to the generation device 10-2. The generation device 10-2 transmits, to the optimization device 20, the template generated by inputting the received input information into the template generative model 12. Then, the initialization unit 202 acquires the template received from the generation device 10-2 as the initial template.

Here, the initialization unit 202 may generate the initial template by using a generative model different from the template generative model 12. Additionally, the initialization unit 202 may generate the initial template by using the target generative model 11.

The evaluation unit 203 evaluates one or more templates (hereinafter also referred to as “evaluation target templates”) based on the target generative model 11. The evaluation target template may include the initial template acquired by the initialization unit 202. The evaluation target template may include a rewritten template obtained by rewriting the initial template one or more times.

The evaluation unit 203 may evaluate the evaluation target template by using the evaluation data read from the evaluation data storage unit 201. Specifically, first, the evaluation unit 203 generates input information to the target generative model 11 by using the evaluation target template for each evaluation data read from the evaluation data storage unit 201, and transmits the generated input information to the generation device 10-1. The generation device 10-1 transmits, to the optimization device 20, an output result obtained when the received input information is input into the target generative model 11. The evaluation unit 203 generates an evaluation result of the evaluation target template based on the output result received from the generation device 10-1.

The evaluation result of the template may be an evaluation value obtained by quantifying the evaluation level. The evaluation value may be a different index depending on the task. For example, when the evaluation is performed using a question answering task, the evaluation value may be the correct answer rate. Additionally, for example, when the evaluation is performed using a translation task, the evaluation value may be the translation accuracy.

The correct answer rate of the question answering task may be calculated as follows, for example. The evaluation unit 203 generates a plurality of pieces of input information for performing the question answering task for each evaluation target template. The input information includes a question sentence and answer options of the question-and-answer data, and includes an instruction to select a correct answer option for the question sentence. The evaluation unit 203 determines whether an output result obtained when the input information is input into the target generative model 11 is correct, and calculates the correct answer rate for each evaluation target template.

The evaluation history storage unit 204 stores history information of evaluation results generated by the evaluation unit 203. The history information of evaluation results may be information obtained by accumulating the evaluation results generated by the evaluation unit 203. The number of history information stored in the evaluation history storage unit 204 is not limited. The history information of evaluation results may include a predetermined number of most recently generated evaluation results, or may include a plurality of evaluation results generated within the most recent predetermined period.

The selection unit 205 selects one or more parent templates to be rewritten from the evaluation target templates based on the evaluation results generated by the evaluation unit 203. The selection unit 205 may select an evaluation target template having a high evaluation as the parent template. The selection unit 205 may select one or more parent templates based on the history information stored in the evaluation history storage unit 204. The selection unit 205 may extract a predetermined number of evaluation target templates having high evaluation values from the history information of evaluation results.

The selection unit 205 may select one or more parent templates according to a predetermined optimization algorithm, for example. The optimization algorithm may include a genetic algorithm, Bayesian optimization, evolution strategy, or reinforcement learning, for example.

In the genetic algorithm, the parent template may be selected using tournament selection, for example. When the tournament selection is used, a predetermined number of evaluation target templates may be randomly extracted from the plurality of evaluation target templates, and an evaluation target template having the highest evaluation value may be selected from them. Additionally, roulette selection may be used as another example.

The rewriting unit 206 obtains a child template by rewriting one or more parent templates selected by the selection unit 205, based on the template generative model 12. Specifically, first, the rewriting unit 206 generates input information to the template generative model 12. The input information includes template information related to one or more parent templates and information specifying the structure of the template. A plurality of pieces of template information may be included. The input information may include an evaluation result of the evaluation target template selected as the parent template.

The template information may include at least one of the template itself or the input information generated using the template. The structure of the template may include, for example, a placeholder indicating a position where a predetermined item is to be embedded. The structure of the template may include, as another example, a type of a markup language describing the template, a type of a symbol used in the template, an order of contents included in the template, or a repetition of items included in the template.

The symbol may be, for example, a list symbol, parentheses in a heading, and the like. The content may be, for example, information indicating an instruction, a context, a condition, or the like, or information obtained by subdividing them. The information specifying the repetition of the item may be the presence or absence of repetition or the number of repetitions of a predetermined item.

The rewriting unit 206 transmits the generated input information to the generation device 10-2. The generation device 10-2 transmits, to the optimization device 20, the template generated by inputting the received input information into the template generative model 12. The rewriting unit 206 acquires the template received from the generation device 10-2 as the child template.

The determination unit 207 determines whether a predetermined convergence condition is satisfied. The predetermined convergence condition is a condition to be satisfied for ending the optimization of the template. The predetermined convergence condition may be, for example, that the template has been rewritten a predetermined number of times, that the difference between the evaluation results before and after the rewriting is within a predetermined threshold value (in other words, the rewriting does not significantly improve the evaluation value), or the like.

### Specific Example of Input Information

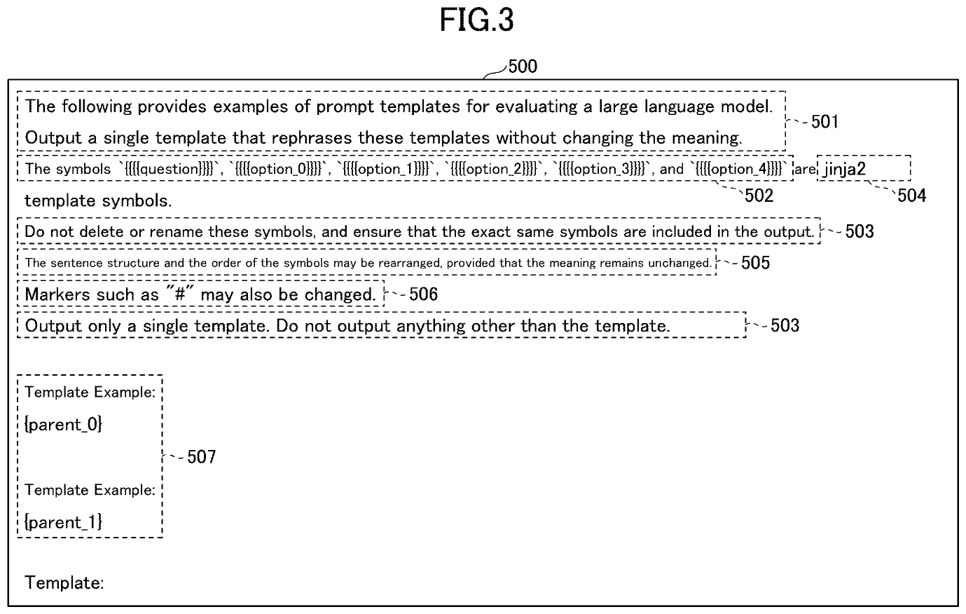

The input information used by the optimization device 20 will be described in detail with reference to FIGS. 3 to 6. The input information used by the optimization device 20 may include, for example, a rewrite prompt and an initial generation prompt. The rewrite prompt is a prompt for the rewriting unit 206 to instruct rewriting of the parent template. The initial generation prompt is a prompt for the initialization unit 202 to instruct generating of the initial template.

### Rewrite Promp

FIG. 3 is a diagram illustrating a first example of a template of the rewrite prompt. As illustrated in FIG. 3, a rewrite prompt template 500 may include a template rewrite instruction 501 (“The following provides examples of prompt templates for evaluating a large language model. Output a single template that rephrases these templates without changing the meaning.”).

The rewrite prompt template 500 may include a placeholder 502 ({{{{question}}}}, {{{{option_0}}}}, {{{{option_1}}}}, {{{{option_2}}}}, {{{{option_3}}}},and {{{{option_4}}}}). Here, “question” denotes a question sentence and “option_0” to “option_4” denote answer options.

The rewrite prompt template 500 may include a constraint 503 (“Do not delete or rename these symbols, and ensure that the exact same symbols are included in the output.” and “Output only a single template. Do not output anything other than the template.”).

The rewrite prompt template 500 may include information 504 (in jinja2 format) specifying a type of a markup language. The rewrite prompt template 500 may include information 505 (“The sentence structure and the order of the symbols may be rearranged, provided that the meaning remains unchanged.”) specifying the order of the contents or the repetition of the item. The rewrite prompt template 500 may include information 506 (“Markers such as “#” may also be changed.”) specifying a type of the symbol.

The rewrite prompt template 500 may include a placeholder 507 (Template Example: {parent_0} and Template Example: {parent_1}) of the template information related to the parent template. The rewrite prompt template 500 illustrated in FIG. 3 includes two placeholders of the template information, but one, or three or more placeholders of the template information may be used. A prompt example generated using the parent template may be embedded in the placeholders of the template information.

In the rewrite prompt template 500 illustrated in FIG. 3, the placeholders {parent_0} and {parent_1} indicating the parent template are described in the placeholder 507 of the template information, but in the rewrite prompt generated using the rewrite prompt template 500, the parent templates selected by the selection unit 205 are embedded in the placeholders {parent_0} and {parent_1}. Here, the parent template may be described in a markup language (in jinja2 format) specified in the rewrite prompt, and may include the placeholder 502 ({{{{question}}}}, {{{{option_0}}}}, {{{{option_1}}}}, {{{{option_2}}}}, {{{{option_3}}}}, and {{{{option_4}}}}).

### Initial Generation Prompt

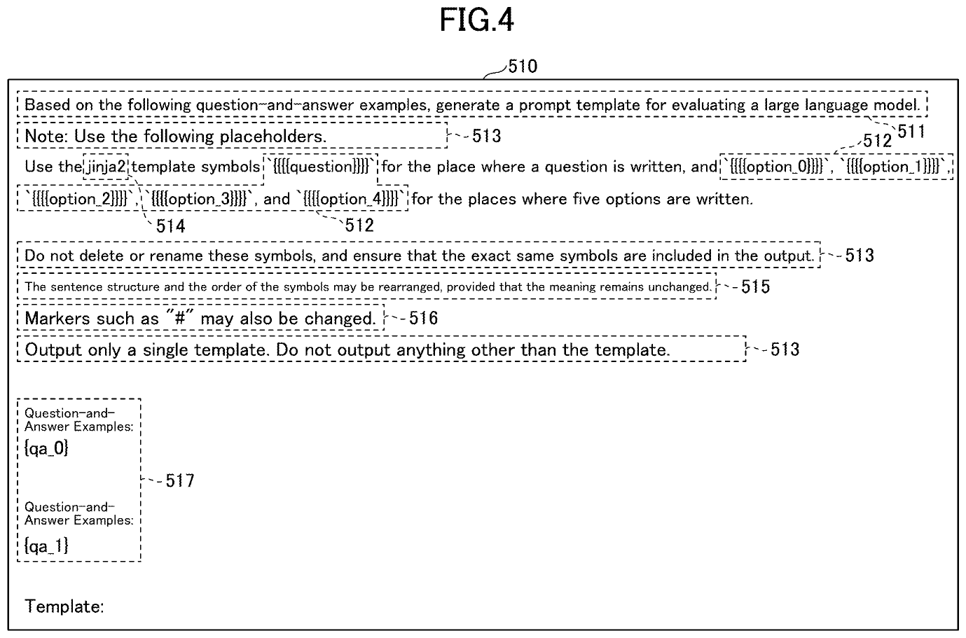

FIG. 4 is a diagram illustrating an example of a template of the initial generation prompt. As illustrated in FIG. 4, an initial generation prompt template 510 may include a template generation instruction 511 (“Based on the following question-and-answer examples, generate a prompt template for evaluating a large language model.”).

The initial generation prompt template 510 may include a placeholder 512 ({{{{question}}}}, {{{{option_0}}}}, {{{{option_1}}}}, {{{{option_2}}}}, {{{{option_3}}}},and {{{{option_4}}}}).

The initial generation prompt template 510 may include a constraint 513 (“Note: Use the following placeholders.”, “Do not delete or rename these symbols, and ensure that the exact same symbols are included in the output.”, and “Output only a single template. Do not output anything other than the template.”).

The initial generation prompt template 510 may include information 514 (in jinja2 format) specifying the type of the markup language. The initial generation prompt template 510 may include information 515 (“The sentence structure and the order of the symbols may be rearranged, provided that the meaning remains unchanged.”) specifying the order of the contents or the repetition of the item. The initial generation prompt may include information 516 (“Markers such as “#” may also be changed.”) specifying the type of symbol.

The initial generation prompt may include an example prompt. The initial generation prompt template 510 illustrated in FIG. 4 includes two prompt examples (“Question-and-Answer Example: {qa_0}” and “Question-and-Answer Example: {qa_1}”) in a placeholder 517, but one, or three or more prompt examples in the placeholder may be used.

In the initial generation prompt template 510 illustrated in FIG. 4, placeholders {qa_0} and {qa_1} indicating question-and-answer examples are described in the placeholder 517 of the example prompt, and in the initial generation prompt generated using the initial generation prompt template 510, question-and-answer examples including question sentences and answer options are embedded in the placeholders {qa_0} and {qa_1}.

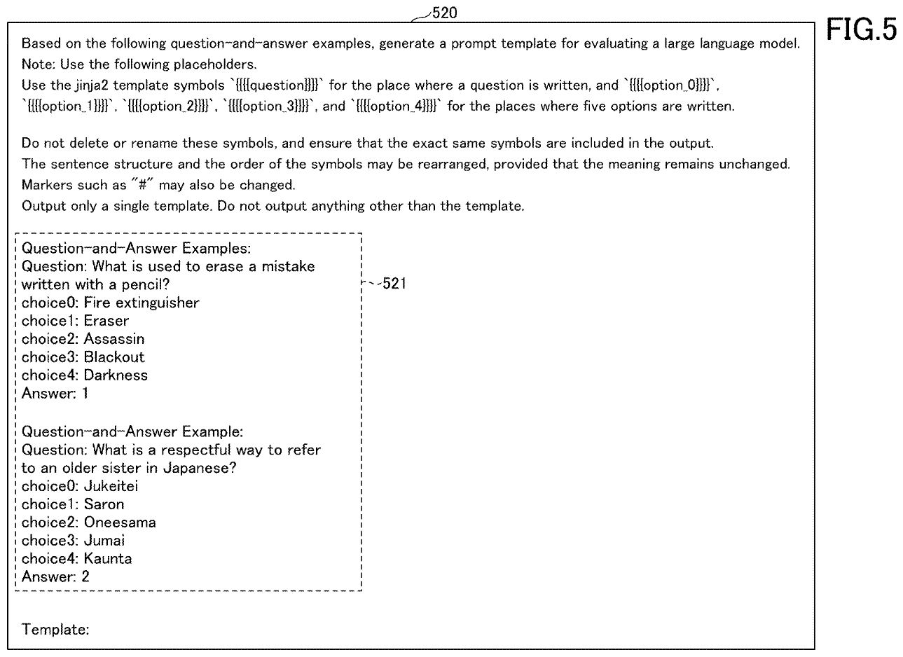

FIG. 5 is a diagram illustrating an example of the initial generation prompt. An initial generation prompt 520 illustrated in FIG. 5 is an initial generation prompt generated using the initial generation prompt template 510 illustrated in FIG. 4. As illustrated in FIG. 5, in the initial generation prompt 520, specific question-and-answer examples are embedded in the placeholders {qa_0} and {qa_1} in the initial generation prompt template 510.

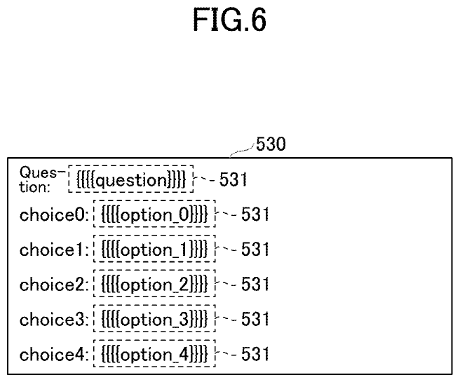

FIG. 6 is a diagram illustrating an example of the initial template. An initial template 530 illustrated in FIG. 6 is an example of an initial template generated by inputting the initial generation prompt 520 illustrated in FIG. 5 into the template generative model 12. As illustrated in FIG. 6, the initial template 530 includes all placeholders 531 ({{{{question}}}}, {{{{option_0}}}}, {{{{option_1}}}}, {{{{option_2}}}}, {{{{option_3}}}}, and {{{{option_4}}}}) designated by the prompt.

### Functional Configuration of Execution Device

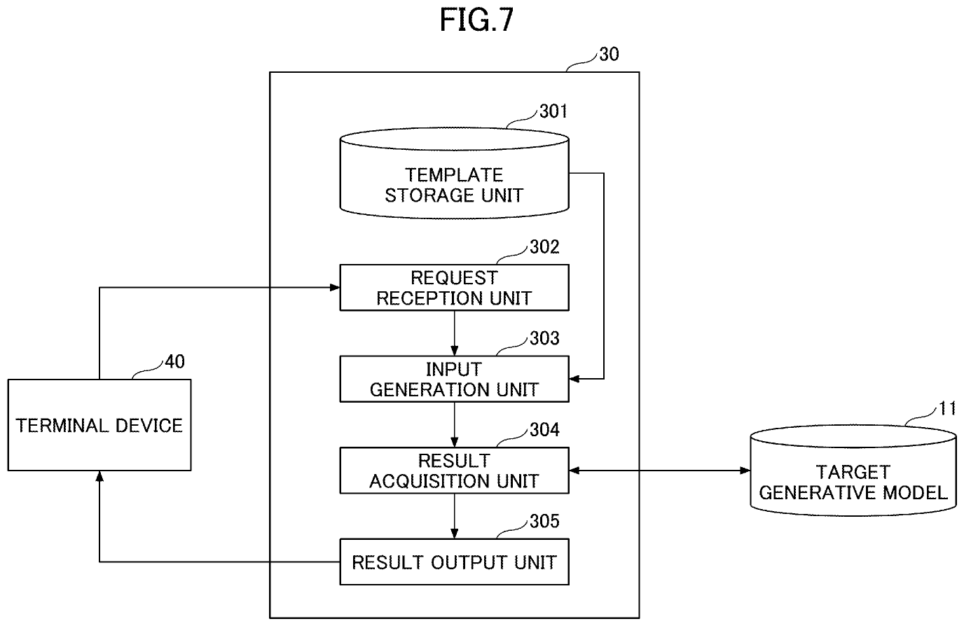

A functional configuration of the execution device 30 will be described with reference to FIG. 7. FIG. 7 is a block diagram illustrating an example of the functional configuration of the execution device according to the first embodiment.

As illustrated in FIG. 7, the execution device 30 includes a template storage unit 301, a request reception unit 302, an input generation unit 303, a result acquisition unit 304, and a result output unit 305. The execution device 30 functions as the template storage unit 301, the request reception unit 302, the input generation unit 303, the result acquisition unit 304, and the result output unit 305 by executing an execution program installed in advance.

The template storage unit 301 stores an optimized template. The optimized template may be the template optimized by the optimization device 20.

The request reception unit 302 receives an input of an execution request from the terminal device 40. The execution request may include input data input to the terminal device 40 by the user. The input data may include data to be embedded in the placeholder included in the template.

The input generation unit 303 generates input information to the target generative model 11 based on the input data received by the request reception unit 302 and the optimized template read from the template storage unit 301. The input generation unit 303 may generate the input information by embedding the input data in the placeholder included in the optimized template.

The result acquisition unit 304 acquires an output result obtained when the input information generated by the input generation unit 303 is input into the target generative model 11. Specifically, first, the result acquisition unit 304 transmits the input information generated by the input generation unit 303 to the generation device 10-1. The generation device 10-1 transmits, to the execution device 30, an output result obtained when the received input information is input into the target generative model 11. Then, the result acquisition unit 304 acquires the output result received from the generation device 10-1.

The result output unit 305 transmits the output result acquired by the result acquisition unit 304 to the terminal device 40. The result output unit 305 may transmit information obtained by processing the output result to the terminal device 40. An example of the processing may be extracting desired information from the output result, embedding predetermined information in the output result, or the like.

### Flow of Optimization Process

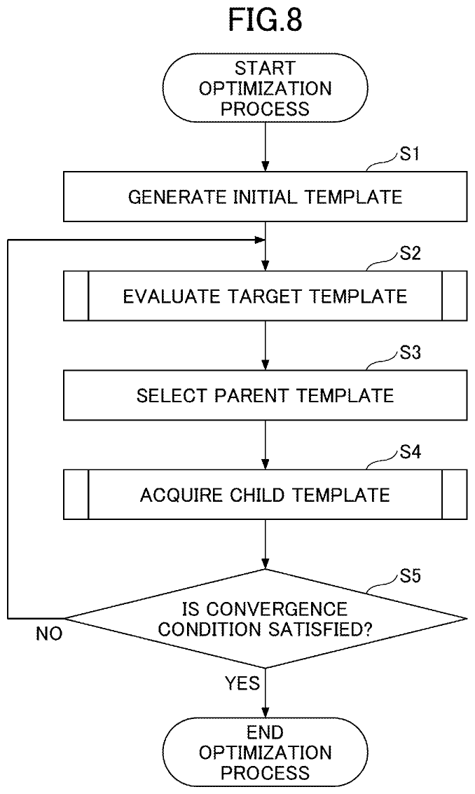

An optimization process performed by the information processing system 1000 will be described with reference to FIGS. 8 to 10. FIG. 8 is a flowchart illustrating an example of the optimization process in the first embodiment. The optimization process optimizes a template for generating input information.

In step S1, the initialization unit 202 of the optimization device 20 acquires one or more initial templates. Here, an example of generating the initial template by using the template generative model 12 will be described.

First, the initialization unit 202 generates input information for instructing generation of a template. Next, the initialization unit 202 transmits the generated input information to the generation device 10-2.

The generation device 10-2 receives the input information from the optimization device 20. Next, the generation device 10-2 inputs the received input information into the template generative model 12. The template generative model 12 generates and outputs the template in accordance with the input information. Then, the generation device 10-2 transmits the output result of the template generative model 12 to the optimization device 20.

The initialization unit 202 receives the output result of the template generative model 12 from the generation device 10-2. Next, the initialization unit 202 acquires an initial template from the received output result. Then, the initialization unit 202 transmits one or more initial templates to the evaluation unit 203.

In step S2, the evaluation unit 203 of the optimization device 20 receives one or more initial templates from the initialization unit 202. Next, the evaluation unit 203 evaluates one or more initial templates as the evaluation target templates based on the target generative model 11. Then, the evaluation unit 203 stores the evaluation result of the evaluation target template in the evaluation history storage unit 204. Additionally, the evaluation unit 203 transmits the evaluation result of the evaluation target template to the selection unit 205.

### Evaluation Process

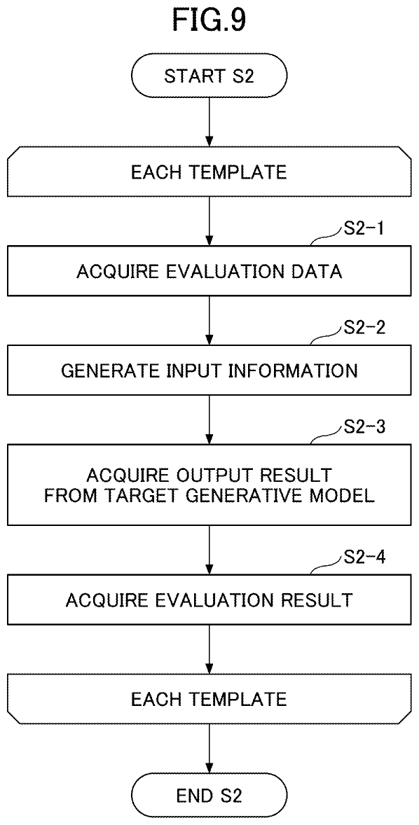

The evaluation process (step S2 in FIG. 8) in the present embodiment will be described in more detail with reference to FIG. 9. FIG. 9 is a flowchart illustrating an example of the evaluation process.

In step S2-1, the evaluation unit 203 of the optimization device 20 reads the evaluation data from the evaluation data storage unit 201. The evaluation unit 203 may read all the evaluation data stored in the evaluation data storage unit 201. The evaluation unit 203 may read a predetermined number of randomly selected evaluation data from the evaluation data stored in the evaluation data storage unit 201.

In step S2-2, the evaluation unit 203 of the optimization device 20 generates input information to the target generative model 11 based on the evaluation data read in step S2-1 and the evaluation target template. For example, the evaluation unit 203 may generate the input information by embedding the evaluation data in the placeholder included in the evaluation target template. The evaluation unit 203 may generate the input information for each of the plurality of pieces of evaluation data read in step S2-1.

In step S2-3, the evaluation unit 203 of the optimization device 20 transmits the input information generated in step S2-2 to the generation device 10-1. The generation device 10-1 receives the input information from the optimization device 20. Next, the generation device 10-1 inputs the received input information into the target generative model 11. The target generative model 11 performs a predetermined task in accordance with the input information and outputs data generated by executing the task. Then, the generation device 10-1 transmits the output result of the target generative model 11 to the optimization device 20.

In step S2-4, the evaluation unit 203 of the optimization device 20 receives the output result of the target generative model 11 from the generation device 10-1. Next, the evaluation unit 203 generates the evaluation result of the evaluation target template based on the received output result. Then, the evaluation unit 203 stores the evaluation result of the evaluation target template in the evaluation history storage unit 204. Additionally, the evaluation unit 203 transmits the evaluation result of the evaluation target template to the selection unit 205.

The evaluation unit 203 performs the processing from step S2-1 to step S2-4 for each of one or more evaluation target templates. The evaluation unit 203 may repeatedly perform the processing from step S2-1 to step S2-4 for each evaluation target template. The evaluation unit 203 may perform the processing for each evaluation target template in parallel in steps from step S2-1 to step S2-4.

The description will be provided, referring back to FIG. 8. In step S3, the selection unit 205 of the optimization device 20 receives the evaluation result of the evaluation target template from the evaluation unit 203. The selection unit 205 may read the history information of the evaluation result from the evaluation history storage unit 204. Next, the selection unit 205 selects one or more parent templates based on the evaluation result of the evaluation target template. The selection unit 205 may select one or more parent templates based on the history information of the evaluation result. Then, the selection unit 205 transmits the selected parent template to the rewriting unit 206.

In step S4, the rewriting unit 206 of the optimization device 20 receives one or more parent templates from the selection unit 205. Next, the rewriting unit 206 acquires a child template obtained by rewriting one or more parent templates based on the template generative model 12.

### Rewriting Process

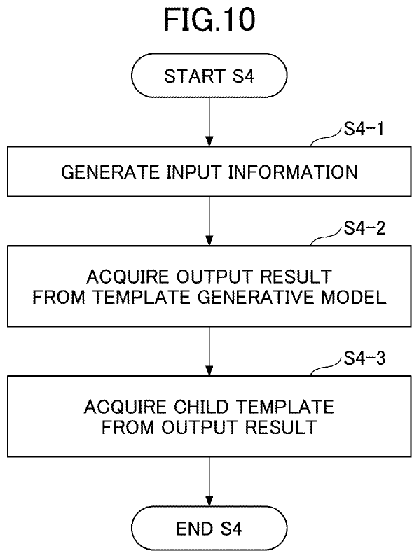

The rewriting process (step S4 in FIG. 8) in the present embodiment will be described in more detail with reference to FIG. 10. FIG. 10 is a flowchart illustrating an example of the rewriting process.

In step S4-1, the rewriting unit 206 of the optimization device 20 generates input information to the template generative model 12 based on one or more parent templates. For example, the rewriting unit 206 may generate input information by embedding the template information related to one or more parent templates in the placeholder of the rewrite prompt.

In step S4-2, the rewriting unit 206 of the optimization device 20 transmits the input information generated in step S4-1 to the generation device 10-2. The generation device 10-2 receives the input information from the optimization device 20. Next, the generation device 10-2 inputs the received input information into the template generative model 12. The template generative model 12 generates and outputs a template in accordance with the input information. Then, the generation device 10-2 transmits the output result of the template generative model 12 to the optimization device 20.

In step S4-3, the rewriting unit 206 of the optimization device 20 receives the output result of the template generative model 12 from the generation device 10-2. Next, the rewriting unit 206 acquires a child template from the received output result.

The description will be provided, referring back to FIG. 8. In step S5, the determination unit 207 of the optimization device 20 determines whether a predetermined convergence condition is satisfied. If the predetermined convergence condition is satisfied (YES), the determination unit 207 outputs the child template acquired in the previous step S4 as the optimized template and ends the optimization process. If the predetermined convergence condition is not satisfied (NO), the determination unit 207 returns the process to step S2.

In step S2 in the second and subsequent times, the evaluation unit 203 performs the evaluation process, using the child template acquired in the previous step S4 as the evaluation target template. Subsequently, the optimization device 20 repeatedly performs the processing from step S2 to step S4 until the predetermined convergence condition is satisfied in step S5.

In the optimization process illustrated in FIG. 8, step S5 in which the determination unit 207 determines whether the predetermined convergence condition is satisfied is performed after step S4 in which the rewriting unit 206 rewrites one or more parent templates, but step S5 may be executed at a different timing. For example, step S5 may be performed after step S2 in which the evaluation unit 203 evaluates the evaluation target template. Step S5 may be performed at any timing according to the contents of the convergence condition.

### Flow of Execution Process

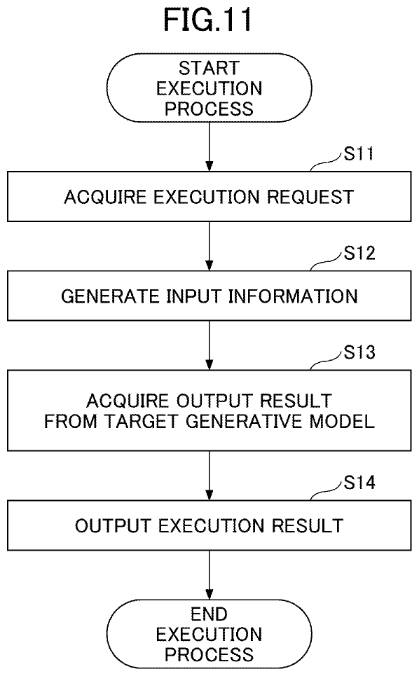

An execution process performed by the information processing system 1000 will be described with reference to FIG. 11. FIG. 11 is a flowchart illustrating an example of the execution process in the first embodiment. The execution process performs a predetermined task based on the optimized template.

In step S11, the user of the information processing system 1000 performs an operation for executing a predetermined task at the terminal device 40. For example, the operation for performing the predetermined task may be an operation for inputting data to be used in the predetermined task to a screen displayed on the display device of the terminal device 40, or an operation for voice-inputting data to be used in the predetermined task to a microphone of the terminal device 40.

The terminal device 40 accepts the operation for executing the predetermined task. Next, the terminal device 40 transmits an execution request of the predetermined task to the execution device 30 in accordance with the accepted operation. The execution request may include data input by the user. The data input by the user may include data to be embedded in the placeholder of the template.

The request reception unit 302 of the optimization device 20 receives the execution request from the terminal device 40. Next, the request reception unit 302 transmits the input data included in the execution request to the input generation unit 303.

In step S12, the input generation unit 303 of the execution device 30 receives the input data from the request reception unit 302. Next, the input generation unit 303 reads the optimized template from the template storage unit 301.

Subsequently, the input generation unit 303 generates input information to the target generative model 11 based on the input data and the optimized template. For example, the input generation unit 303 may generate the input information by embedding the input data in the placeholder included in the optimized template. Then, the input generation unit 303 transmits the generated input information to the result acquisition unit 304.

In step S13, the result acquisition unit 304 of the execution device 30 receives the input information from the input generation unit 303. Next, the result acquisition unit 304 transmits the input information to the generation device 10-1.

The generation device 10-1 receives the input information from the execution device 30. Next, the generation device 10-1 inputs the received input information into the target generative model 11. The target generative model 11 performs the predetermined task in accordance with the input information and outputs data generated by performing the task. Then, the generation device 10-1 transmits the output result of the target generative model 11 to the execution device 30.

The result acquisition unit 304 receives the output result of the target generative model 11 from the generation device 10-1. Next, the result acquisition unit 304 transmits the received output result to the result output unit 305.

In step S14, the result output unit 305 of the execution device 30 receives the output result of the target generative model 11 from the result acquisition unit 304. Next, the result output unit 305 transmits the received output result to the terminal device 40. The result output unit 305 may transmit data obtained by processing the received output result to the terminal device 40.

The terminal device 40 receives the output result of the target generative model 11 from the execution device 30. Next, the terminal device 40 presents the received output result to the user. For example, the terminal device 40 may display a screen including the output result on the display device. For example, the terminal device 40 may emit a voice synthesized with the output result from a speaker.

### Modified Example 1

As a method of prompt engineering, a method of including a numerical vector called a soft prompt in input information to a generative model is known. The soft prompt is a vector having a structure similar to a word vector and not based on a specific word. In the method, the soft prompt is included in the input information to the generative model, and the value of the soft prompt is optimized so that a desired output result can be obtained from the generative model.

In the method, the position of the soft prompt in the input information is fixed. For example, the soft prompt is embedded at the beginning or end of the input information. By optimizing the position of the soft prompt in addition to the value of the soft prompt, a more desired output result can be expected. In the modified example, a template including a placeholder indicating the position where the soft prompt is embedded is optimized.

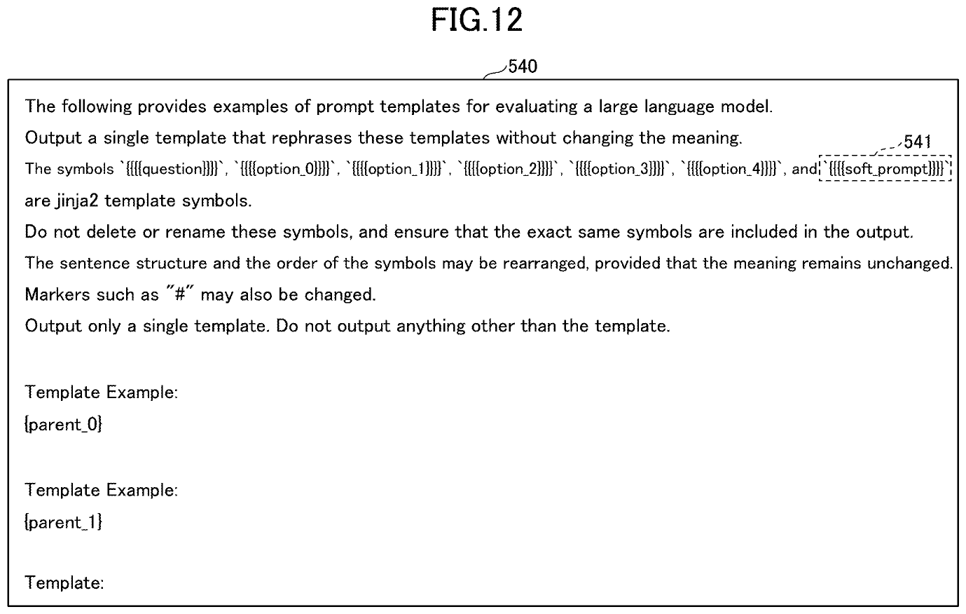

FIG. 12 is a diagram illustrating a second example of the rewrite prompt template. As illustrated in FIG. 12, a rewrite prompt template 540 may include a placeholder 541 ({{{soft_prompt}}}) indicating the position of the soft prompt. The rewrite prompt template 540 may be substantially the same as the rewrite prompt template 500 in the first embodiment except that the template includes the placeholder 541 indicating the position of the soft prompt.

### Functional Configuration of Optimization Device

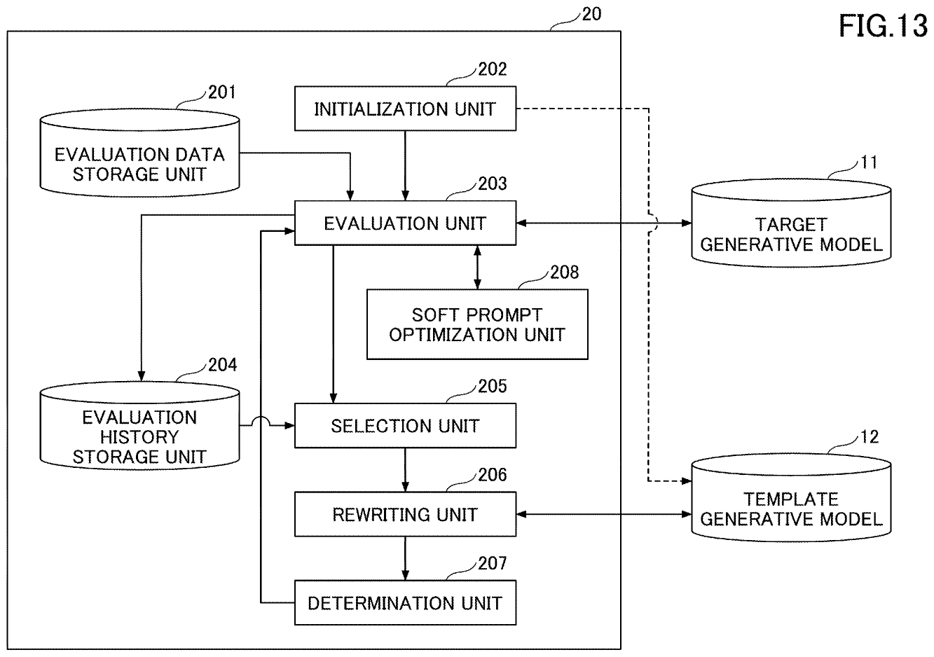

A functional configuration of the optimization device in the modified example will be described with reference to FIG. 13. FIG. 13 is a block diagram illustrating an example of the functional configuration of the optimization device in Modified Example 1.

As illustrated in FIG. 13, the optimization device 20 includes the evaluation data storage unit 201, the initialization unit 202, the evaluation unit 203, the evaluation history storage unit 204, the selection unit 205, the rewriting unit 206, the determination unit 207, and a soft prompt optimization unit 208. That is, the optimization device 20 in the Modified Example 1 differs from the first embodiment in that it further includes the soft prompt optimization unit 208.

The soft prompt optimization unit 208 optimizes the soft prompt. First, the soft prompt optimization unit 208 generates an initial soft prompt. The initial soft prompt may be, for example, a random numerical vector or a predetermined numerical vector.

Next, the soft prompt optimization unit 208 evaluates the soft prompt. The evaluation method of the soft prompt may be substantially the same as that of the evaluation target template. That is, the soft prompt optimization unit 208 generates input information in which the soft prompt and the evaluation data are embedded in the placeholder of the evaluation target template, and transmits the input information to the generation device 10-1. Then, the soft prompt optimization unit 208 generates the evaluation result of the soft prompt based on the output result received from the generation device 10-1.

Subsequently, the soft prompt optimization unit 208 optimizes the soft prompt based on the evaluation result of the soft prompt. The optimization algorithm may be, for example, Bayesian optimization or evolutionary computation. The soft prompt optimization unit 208 may search for the optimum soft prompt based on the evaluated soft prompt and its evaluation result by adding a trade-off between exploration and exploitation. When the soft prompt converges, the soft prompt optimization unit 208 transmits the optimized soft prompt to the evaluation unit 203.

In the modified example, the evaluation unit 203 evaluates the evaluation target template by using the soft prompt optimized by the soft prompt optimization unit 208 and the evaluation data. The selection unit 205 selects one or more parent templates to be rewritten from the evaluation target template based on the evaluation result generated by the evaluation unit 203. The rewriting unit 206 generates a child template obtained by rewriting one or more parent templates selected by the selection unit 205, based on the template generative model 12. The evaluation unit 203, the selection unit 205, and the rewriting unit 206 repeatedly perform the process until the determination unit 207 determines that the predetermined convergence condition is satisfied.

### Modified Example 2

In the first embodiment, the configuration in which the evaluation value indicating the evaluation result of the evaluation target template is calculated based on the output result of the target generative model 11 has been described. Modified Example 2 describes a configuration in which the output result of the target generative model 11 is presented to the user and the evaluation result of the evaluation target template is acquired based on feedback information from the user.

The user from whom the feedback information is acquired may be the same person as the user who performs the predetermined task using the optimized template or a different person. The user from whom the feedback information is acquired may be a plurality of persons. In other words, the user from whom the feedback information is acquired may or may not include a user who operates the execution device 30.

The modified example may be used when it is difficult to quantify the evaluation of the template based on the output result. In the first embodiment, the template is evaluated using the question answering task. In this case, the rate of correct answers to the questions can be calculated as the evaluation value. With respect to the above, there is a task for which it is difficult to quantify the evaluation of the output result. For example, in tasks such as document summarization, translation, image generation, and musical sound generation, evaluating the output result by a uniform standard may be inappropriate. In this kind of task, by collecting feedback information indicating the evaluation by the user, the template can be optimized so as to obtain the output result that the user feels appropriate.

The collection of the feedback information may be performed by using a black-box optimization tool, for example. The black-box optimization tool may be, for example, Optuna (registered trademark). The black-box optimization tool may be pre-installed in the terminal device 40. The black-box optimization tool may be installed in the optimization device 20, and may be configured such that the feedback information from the user is acquired by the terminal device 40.

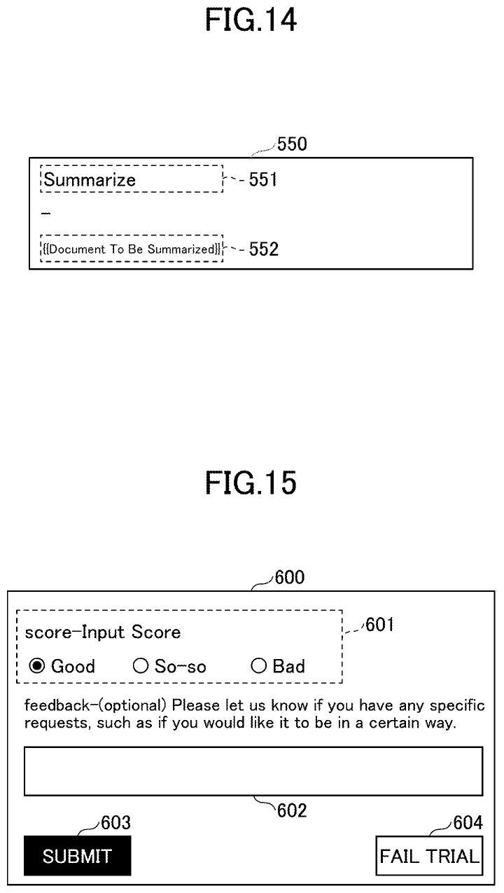

FIG. 14 is a diagram illustrating an example of a prompt template in Modified Example 2. As illustrated in FIG. 14, a prompt template 550 in Modified Example 2 may include a document summary instruction 551 (“Summarize”). The prompt template 550 may include a single placeholder 552 ({{Document To Be Summarized}}) in which a document to be summarized is embedded.

In the present embodiment, upon receiving the output result of the target generative model 11 from the generation device 10-1, the evaluation unit 203 presents the received output result to the user. For example, the evaluation unit 203 may cause the display device of the terminal device 40 to display a feedback screen for accepting feedback information from the user. Specifically, the evaluation unit 203 may transmit screen data for displaying the feedback screen to the terminal device 40, and the terminal device 40 having received the screen data may display the feedback screen on the display device based on the screen data.

The feedback screen may include an area for displaying the output result of the target generative model 11. The feedback screen may include a feedback information input field for inputting the feedback information from the user. The feedback information may include, for example, an evaluation value indicating an evaluation result by the user. The feedback information may include, for example, free text.

FIG. 15 is a diagram illustrating an example of the feedback information input field. As illustrated in FIG. 15, a feedback information input field 600 may include an evaluation value input field 601, a text input field 602, a post button 603, and a stop button 604.

The evaluation value input field 601 may include evaluation options. Each option may be associated with a predetermined evaluation value. The evaluation options may be, for example, “Good”, “So-so”, or “Bad”. The evaluation options may be, for example, numerical values, characters, or symbols indicating evaluation values. The evaluation options may be, for example, about three to five levels.

The evaluation value input field 601 may accept, for example, input of an evaluation value by an operation of a radio button. The evaluation value input field 601 may accept, for example, input of an evaluation value by an operation of a slider. The evaluation value input field 601 may accept input of continuous values or input of discrete values.

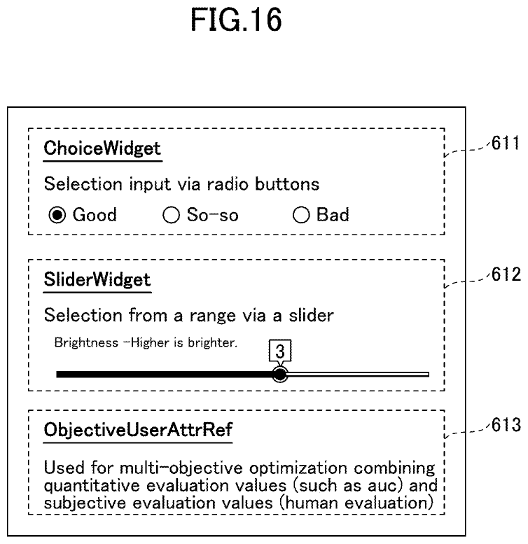

FIG. 16 is a diagram illustrating an example of the evaluation value input field. As illustrated in FIG. 16, the evaluation value input field 601 may be an input form 611 for selecting an evaluation value by operating a radio button, an input form 612 for adjusting an evaluation value by operating a slider, or an input form 613 for performing multi-objective optimization. The multi-objective optimization may be performed by combining a quantitative evaluation value (Area Under the Curve (AUC) and the like) and a subjective evaluation value (human). The user (for example, a programmer or a general user) may select which of the input forms 611 to 613 illustrated in FIG. 16 is used.

The user may refer to the output result displayed on the feedback screen and input feedback information for the output result in the feedback information input field 600. The feedback information may be acquired by recognizing the voice of the user. The feedback information may be acquired by selecting one or more output results that the user feels are good or one or more output results that the user feels are not good from among a plurality of output results generated using a plurality of evaluation target templates.

The input of the evaluation value by the user may be performed in a user interface for comparative evaluation that displays a plurality of output results simultaneously and causes the user to select an output result with a high evaluation for the user. In the user interface, the evaluation value of the selected output result may be higher than the evaluation value of the unselected output result. In the user interface, a value indicating how much a certain output result is superior to another output result may be input using a slider or the like. Additionally, in the user interface, the output result of the target generative model 11 may be processed by a program in order to perform comparative evaluation.

The input of the evaluation value by the user may be performed in a user interface for ranking evaluation that displays a plurality of output results simultaneously and causes the user to rank them. Additionally, the input of the evaluation value by the user may be performed by changing the evaluation value calculated by the terminal device 40 or the optimization device 20. Furthermore, the input of the evaluation value by the user may be performed by combining the evaluation value input by the user and the evaluation value calculated by the terminal device 40 or the optimization device 20.

When the user presses the post button 603 after inputting feedback information, the terminal device 40 acquires the feedback information input in the feedback information input field 600 and transmits it to the optimization device 20. In the optimization device 20, the evaluation unit 203 receives the feedback information from the terminal device 40. The evaluation unit 203 acquires the evaluation result from the received feedback information. Then, the evaluation unit 203 transmits the evaluation result of the evaluation target template to the selection unit 205.

When the user presses the stop button 604 without inputting feedback information, the terminal device 40 transmits a signal indicating that the evaluation is stopped to the optimization device 20. In the optimization device 20, the evaluation unit 203 receives the signal indicating that evaluation is stopped from the terminal device 40. The evaluation unit 203 may exclude the evaluation target template for which the signal indicating that evaluation is stopped is received from the evaluation target.

Subsequently, the optimization device 20 optimizes the template based on the feedback information. Specifically, the optimization device 20 selects a parent template to be embedded in the rewrite prompt by an optimization algorithm using the feedback information as the evaluation result of the evaluation target template. As the optimization algorithm based on the feedback information, for example, a black-box optimization method or a gray-box optimization method may be used. The feedback information may be acquired from the user or may be automatically generated by the terminal device 40. The black-box optimization method and the gray-box optimization method are examples of the optimization algorithm based on the feedback information.

The black-box optimization method may be, for example, a multi-objective optimization method, a Bayesian optimization method, an evolutionary computation method, or the like. The gray-box optimization method may be, for example, a multi-fidelity optimization method or the like. Specifically, the black-box optimization method may use a technique such as Tree-Structured Parzen Estimator (TPE), Gaussian Process-Bayesian Optimization (GP-BO), CMA-ES, Non-Dominated Sorting Genetic Algorithm-II (NSGA-II), or the like.

### Modified Example 3

The optimization device 20 may optimize parameters of the generative model for generating the template. In the modified example, a configuration in which the optimization device 20 optimizes parameters of the template generative model 12 by reinforcement learning will be described, for example.

In the modified example, the optimization device 20 generates input information to the template generative model 12. The input information to the template generative model 12 may be a prompt for instructing the generation of the template. The input information to the template generative model 12 may or may not include a template selected according to the optimization algorithm.

The input information to the template generative model 12 may be, for example, a rewrite prompt generated using the rewrite prompt template 500 illustrated in FIG. 3, an initial generation prompt generated using the initial generation prompt template 510 illustrated in FIG. 4, or the initial generation prompt 520 illustrated in FIG. 5.

The optimization device 20 transmits, to the generation device 10-2, the input information to the template generative model 12. The generation device 10-2 transmits the template generated by inputting the received input information into the template generative model 12 to the optimization device 20.

The optimization device 20 evaluates the template received from the generation device 10-2. The optimization device 20 may evaluate the template based on the target generative model 11, for example. The optimization device 20 may evaluate the template by using evaluation data read from the evaluation data storage unit 201, for example. Then, the optimization device 20 performs reinforcement learning of the parameters of the template generative model 12 by using the input information to the target generative model 11 as an action and an evaluation value indicating the evaluation result of the template as a reward.

### Second Embodiment

In the first embodiment, the configuration in which the template is optimized so that the output result having a high evaluation value can be obtained from the generative model, and the predetermined task is performed based on the optimized template has been described. In the second embodiment, a configuration in which the template is optimized so that an output result having a low evaluation value can be obtained from the generative model, and additional learning is performed on the generative model based on the optimized template will be described.

Hereinafter, an information processing system in the second embodiment will be described focusing on differences from the first embodiment.

### Functional Configuration of Optimization Device

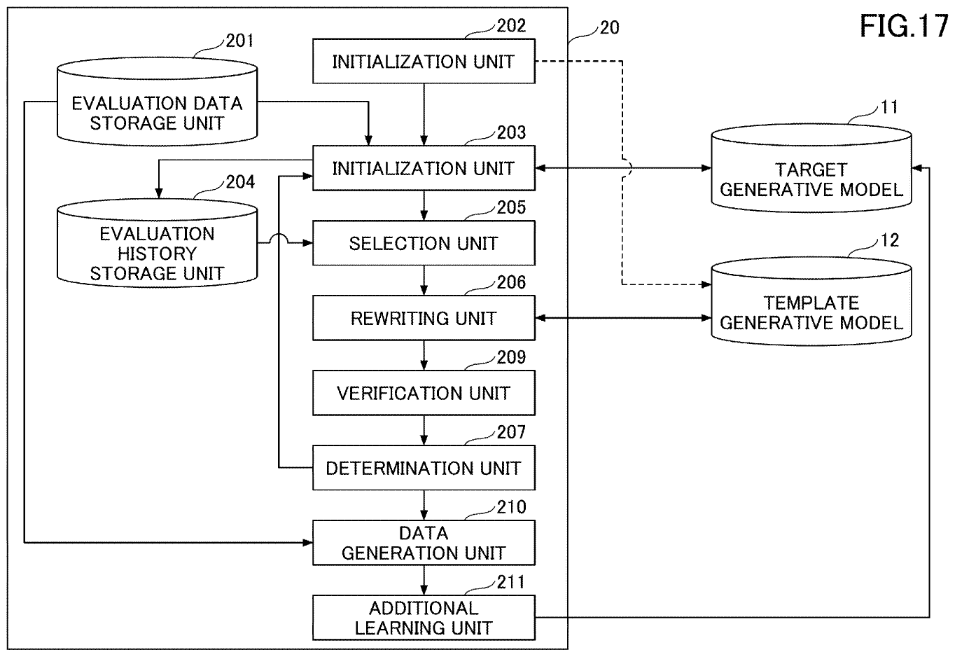

A functional configuration of the optimization device according to the present embodiment will be described with reference to FIG. 17. FIG. 17 is a block diagram illustrating an example of the functional configuration of the optimization device according to the second embodiment.

As illustrated in FIG. 17, the optimization device 20 includes the evaluation data storage unit 201, the initialization unit 202, the evaluation unit 203, the evaluation history storage unit 204, the selection unit 205, the rewriting unit 206, the determination unit 207, a verification unit 209, a data generation unit 210, and an additional learning unit 211. That is, the optimization device 20 in the second embodiment differs from the first embodiment in that it further includes the verification unit 209, the data generation unit 210, and the additional learning unit 211.

In the present embodiment, the selection unit 205 selects an evaluation target template having a lower evaluation as the parent template. For example, when the evaluation data is question-and-answer data, the selection unit 205 may select one or more evaluation target templates having a lower correct answer rate in the question answering task.

The verification unit 209 verifies whether the template generated by the template generative model 12 satisfies a predetermined requirement. The template to be verified may include an initial template acquired by the initialization unit 202 or a child template generated by the rewriting unit 206.

The predetermined requirement is a requirement to be satisfied by the template. The predetermined requirement may include, for example, that all necessary placeholders are included in the template and that at least a content indicating an instruction is included.

The data generation unit 210 generates a data set based on the optimized template. The data set may include input information to the target generative model 11 and a correct answer of the output result. The data generation unit 210 may generate a data set based on the evaluation data read from the evaluation data storage unit 201. For example, the data generation unit 210 may generate input information including a question sentence and answer options included in the question-and-answer data by using the optimized template, and generate a data set including the input information and a correct answer option included in the question-and-answer data.

The additional learning unit 211 performs additional learning on the target generative model 11 based on the data set generated by the data generation unit 210. The additional learning method may be, for example, fine tuning. As another example, the additional learning method may be Low-Rank Adaptation (LoRA) or Quantized Low-Ranking Adaptation (QLoRA).

### Flow of Additional Learning Process

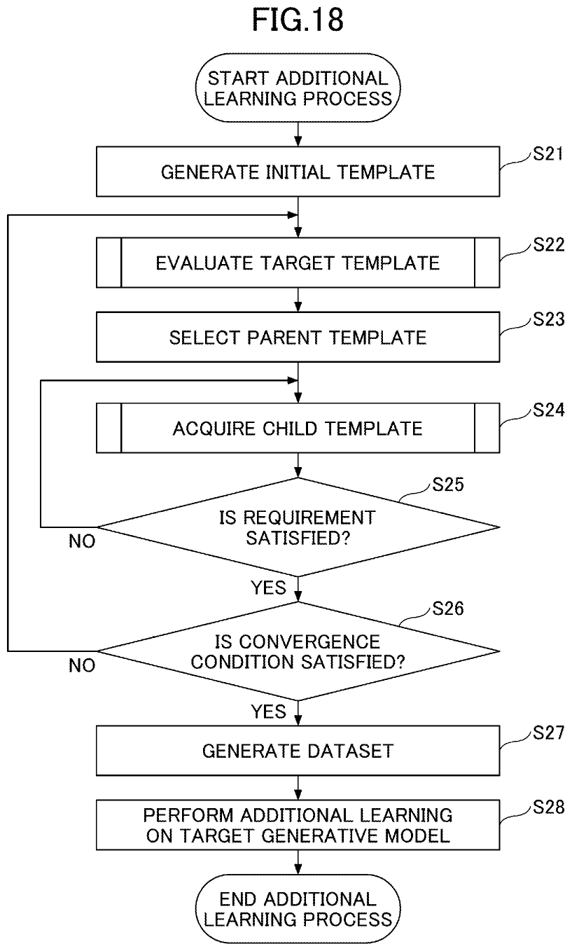

An additional learning process performed by the information processing system 1000 in the second embodiment will be described with reference to FIG. 18. FIG. 18 is a flowchart illustrating an example of the additional learning process.

The processing from step S21 to step S24 are substantially the same as the processing from step S1 to step S4 in the first embodiment (see FIG. 8). However, in the present embodiment, in step S23, the selection unit 205 selects an evaluation target template having a low evaluation as the parent template.

In step S25, the verification unit 209 of the optimization device 20 receives the child template from the rewriting unit 206. Next, the verification unit 209 verifies whether the received child template satisfies the predetermined requirement.

If the child template satisfies the predetermined requirement (YES), the verification unit 209 proceeds the process to step S26. If the child template does not satisfy the predetermined requirement (NO), the verification unit 209 discards the child template and returns the process to step S24.

In step S26, the determination unit 207 of the optimization device 20 determines whether a predetermined convergence condition is satisfied. In the present embodiment, the predetermined convergence condition may be, for example, that the evaluation value obtained in step S22 is less than or equal to a predetermined threshold value. The threshold value may be determined, for example, based on the lowest evaluation value among the evaluation values obtained by evaluating the existing templates.

If the predetermined convergence condition is satisfied (YES), the determination unit 207 transmits the child template acquired in the preceding step S24 to the data generation unit 210 as the optimized template, and proceeds the process to step S27. If the predetermined convergence condition is not satisfied (NO), the determination unit 207 returns the process to step S22.

In step S27, the data generation unit 210 of the optimization device 20 receives the optimized template from the determination unit 207. Next, the data generation unit 210 reads the evaluation data from the evaluation data storage unit 201. Subsequently, the data generation unit 210 generates a data set based on the evaluation data and the optimized template. For example, the data generation unit 210 may generate the data set by embedding the evaluation data in the placeholder included in the optimized template. Then, the data generation unit 210 transmits the generated data set to the additional learning unit 211.

In step S28, the additional learning unit 211 of the optimization device 20 receives the data set from the data generation unit 210. Next, the additional learning unit 211 performs additional learning on the target generative model 11 based on the received data set. For example, the additional learning unit 211 may fine-tune the target generative model 11 based on the received data set.

The additional learning process may be repeatedly performed. For example, when the evaluation result, obtained when the target generative model 11 after the completion of the additional learning process is used to evaluate the evaluation target template, is not improved, the additional learning process may be performed again.

### Application Example

In the embodiments of the present disclosure, the example of using a large-scale language model for generating text data has been described as an example of the generative model, but the use of the generative model is not limited thereto. The use of the generative model may be, for example, image generation, code review, material generation, finance, and the like.

The image generation may be the generation of a character such as an animation character. The material generation may be the generation of a substance from a material. The code review may select items such as tests, data structures, and documents by black-box optimization. As a variation of the item, there may be an item of a property viewpoint, such as consistency, maintainability, and error. Further, as a variation of the item, there may be an item of a context (a difference of codes). The finance may be the creation of an individual stock investment strategy.

### Summary

As is apparent from the above description, the optimization device 20 according to the embodiment of the present disclosure acquires the evaluation result obtained by evaluating one or more evaluation target templates using the target generative model 11, generates the input information to the template generative model 12 based on the evaluation result, and acquires the template generated by inputting the input information into the template generative model 12. The input information includes at least one or more pieces of template information selected based on the evaluation result and the information specifying the structure of the template.

The optimization device 20 may repeatedly perform the acquiring of the evaluation result obtained by using the acquired template as one or more evaluation target templates, the generating of the input information based on the evaluation result, and the acquiring of the template, until a predetermined condition is satisfied.

The information specifying the structure of the template may include a placeholder indicating a position where a predetermined item is embedded. The placeholder may include a placeholder indicating a position where a predetermined numerical vector is embedded. The information specifying the structure of the template may include information specifying at least one of the type of the markup language, the type of the symbol, the order of the contents, or the repetition of the item.

The optimization device 20 may generate the input information based on the template selected from one or more evaluation target templates by the optimization algorithm using the evaluation result. The optimization device 20 may select one or more templates having a high evaluation value indicating the evaluation result among the one or more evaluation target templates. The optimization device 20 may select one or more templates having a high evaluation value indicating the evaluation result among a plurality of templates suitably selected from the one or more evaluation target templates.

The optimization device 20 may generate the template information based on a learned model in which a relationship between the input information generated using the evaluation target template and the evaluation result obtained by evaluating the evaluation target template is learned. The learned model may be subjected to reinforcement learning using the input information as the action and the evaluation result as the reward.

The optimization device 20 may generate the input information to the target generative model 11 by using one or more evaluation target templates, acquire the output result generated by inputting the input information into the target generative model 11, and acquire the evaluation result based on the output result. The input information to the target generative model 11 may be input information for performing a task for answering a question, and the evaluation result may be information indicating a correct answer rate included in the output result. The optimization device 20 may present the output result to the user and acquire the evaluation result based on the feedback information acquired from the user.

The optimization device 20 may generate an evaluation target template based on a generative model different from the target generative model 11 and the template generative model 12.

The optimization device 20 may generate the template information based on one or more templates having a low evaluation value indicating the evaluation result among the one or more evaluation target templates. The optimization device 20 may generate the data set including the input information to the target generative model 11 by using the acquired template, and the data set may be a data set used for additional learning of the target generative model 11.

The target generative model 11 and the template generative model 12 may be the same generative model.

With this, according to the embodiment of the present disclosure, a technique for optimizing the template for generating the input information to the generative model can be provided. In one aspect, according to the embodiment, a desired output result can be obtained from the generative model without changing the semantic content of the input information. In another aspect, according to the embodiment, additional learning can be performed on the generative model so that a desired output result can be obtained by using the input information by which it is found that a desired output result cannot be obtained from the generative model.

### Hardware Configuration of Information Processing Device

Some or all of the devices (the generation device 10, the optimization device 20, the execution device 30, and the terminal device 40) in the above-described embodiments may be configured by hardware or may be configured by information processing of software (program) executed by a central processing unit (CPU), a graphics processing unit (GPU), or the like. In the case where the embodiment is configured by the information processing of software, software for realizing at least some of the functions of the devices in the above-described embodiments may be stored in a non-transitory storage medium (a non-transitory computer-readable medium), such as a compact disc-read only memory (CD-ROM) or a universal serial bus (USB) memory, and a computer may read the software to perform the information processing of the software. Additionally, the software may be downloaded via a communication network. Furthermore, all or some of the processes of software may be implemented in a circuit, such as an application specific integrated circuit (ASIC) or a field programmable gate array (FPGA), and the information processing by the software may be executed by hardware.

The storage medium storing the software may be a removable medium, such as an optical disk, or a fixed storage medium, such as a hard disk or a memory. Additionally, the storage medium may be provided inside the computer (a main storage device, an auxiliary storage device, or the like) or may be provided outside the computer.

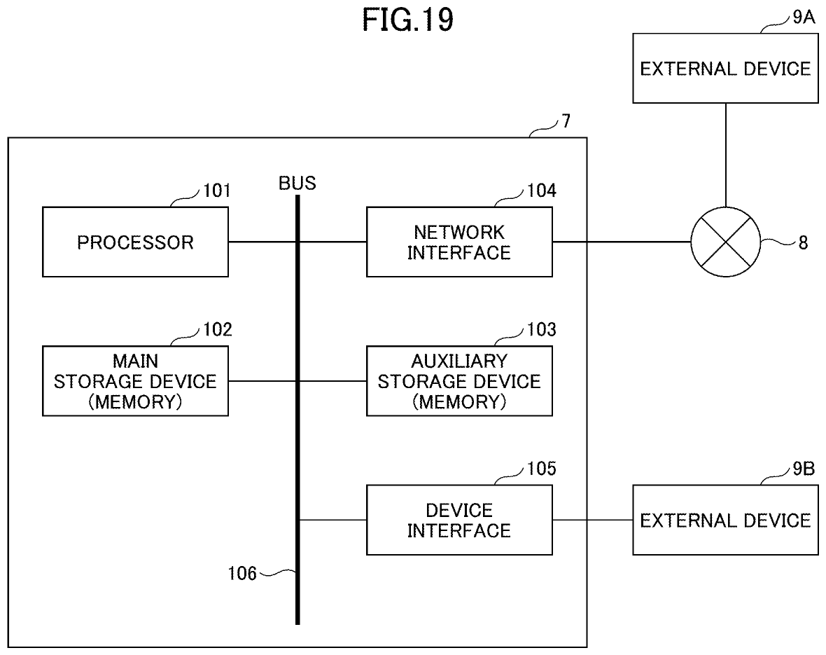

FIG. 19 is a block diagram illustrating an example of a hardware configuration of the devices (the generation device 10, the optimization device 20, the execution device 30, and the terminal device 40) in the above-described embodiments. Each of the devices may be implemented as a computer 7 including a processor 71, a main storage device 72 (memory), an auxiliary storage device 73 (memory), a network interface 74, and a device interface 75, which are connected via a bus 76, for example.

The computer 7 of FIG. 19 includes one of each component, but may include multiple units of the same components. Additionally, although FIG. 19 illustrates one computer 7, the software may be installed in multiple computers, and the multiple computers may execute the same or different partial processes of the software. In this case, the computers may be in a distributed computing form in which the computers communicate with each other via the network interface 74 or the like to perform the processes. That is, the devices (the generation device 10, the optimization device 20, the execution device 30, and the terminal device 40) in the above-described embodiments may be configured as a system that realizes a function by one or more computers executing instructions stored in one or more storage devices. Additionally, the devices may be configured such that information transmitted from a terminal may be processed by one or more computers provided on a cloud, and the processing result may be transmitted to the terminal.

The various operations of the devices (the generation device 10, the optimization device 20, the execution device 30, and the terminal device 40) in the above-described embodiments may be performed by parallel processing using one or more processors or using multiple computers connected via a network. Additionally, various operations may be distributed to multiple operation cores in the processor and performed by parallel processing. Additionally, some or all of the processes, means, and the like of the present disclosure may be implemented by at least one of a processor or a storage device provided on a cloud that can communicate with the computer 7 via a network. As described above, each of the devices in the above-described embodiments may be in a form of parallel computing by one or more computers.

The processor 71 may be an electronic circuit (a processing circuit, processing circuitry, a CPU, a GPU, an FPGA, an ASIC, or the like) that performs at least one of control or operations of a computer. Additionally, the processor 71 may be any of a general-purpose processor, a dedicated processing circuit designed to execute a specific operation, or a semiconductor device including both the general-purpose processor and the dedicated processing circuit. Additionally, the processor 71 may include an optical circuit or may include an arithmetic function based on quantum computing.

The processor 71 may perform arithmetic processing based on data or software input from each device or the like of the internal configuration of the computer 7, and may output an arithmetic result or a control signal to each device or the like. The processor 71 may control each component constituting the computer 7 by executing an operating system (OS), an application, or the like of the computer 7.

The devices (the generation device 10, the optimization device 20, the execution device 30, and the terminal device 40) in the above-described embodiments may be implemented by one or more processors 71. Here, the processor 71 may refer to one or more electronic circuits disposed on one chip, or may refer to one or more electronic circuits disposed on two or more chips or two or more devices. When multiple electronic circuits are used, the electronic circuits may communicate with each other by wire or wirelessly.

The main storage device 72 may store instructions executed by the processor 71, various data, and the like, and information stored in the main storage device 72 may be read by the processor 71. The auxiliary storage device 73 is a storage device other than the main storage device 72. Here, these storage devices indicate any electronic components capable of storing electronic information, and may be semiconductor memories. The semiconductor memory may be either a volatile memory or a nonvolatile memory. The storage device for storing various data and the like in the device in the above-described embodiments (the generation device 10, the optimization device 20, the execution device 30, and the terminal device 40) may be realized by the main storage device 72 or the auxiliary storage device 73, or may be realized by a built-in memory built in the processor 71. For example, the storage devices in the above-described embodiments may be realized by the main storage device 72 or the auxiliary storage device 73.

When the device in the above-described embodiments (the generation device 10, the optimization device 20, the execution device 30, and the terminal device 40) includes at least one storage device (memory) and at least one processor connected (coupled) to the at least one storage device, the at least one processor may be connected to one storage device. Additionally, at least one storage device may be connected to one processor. Additionally, a configuration in which at least one processor among the multiple processors is connected to at least one storage device among the multiple storage devices may be included. Additionally, this configuration may be realized by storage devices and the processors included in multiple computers. Furthermore, a configuration in which the storage device is integrated with the processor (for example, an L1 cache or a cache memory including an L2 cache) may be included.

The network interface 74 is an interface for connecting to a communication network 8 by wire or wirelessly. As the network interface 74, an appropriate interface, such as one conforming to an existing communication standard, may be used. The network interface 74 may exchange information with an external device 9A connected via the communication network 8. Here, the communication network 8 may be any one of a wide area network (WAN), a local area network (LAN), a personal area network (PAN), and the like, or a combination thereof, as long as information is exchanged between the computer 7 and the external device 9A. Examples of the WAN include the Internet and the like, and examples of the LAN include IEEE802.11, Ethernet (registered trademark), and the like. Examples of the PAN include Bluetooth (registered trademark), Near Field Communication (NFC), and the like.

The device interface 75 is an interface, such as a USB, that is directly connected to an external device 9B.

The external device 9A is a device connected to the computer 7 via a network. The external device 9B is a device directly connected to the computer 7.

The external device 9A or the external device 9B may be, for example, an input device. The input device is, for example, a device, such as a camera, a microphone, a motion capture device, various sensors, a keyboard, a mouse, a touch panel, or the like, and gives acquired information to the computer 7. Alternatively, the device may be a device including an input unit, a memory, and a processor, such as a personal computer, a tablet terminal, or a smartphone.

Additionally, the external device 9A or the external device 9B may be, for example, an output device. The output device may be, for example, a display device, such as a liquid crystal display (LCD) or an organic electro luminescence (EL) panel, or may be a speaker that outputs sound or the like. Alternatively, the device may be a device including an output unit, a memory, and a processor, such as a personal computer, a tablet terminal, or a smartphone.

Additionally, the external device 9A or the external device 9B may be a storage device (a memory). For example, the external device 9A may be a network storage or the like, and the external device 9B may be a storage, such as a hard disk drive (HDD).

Additionally, the external device 9A or the external device 9B may be a device having a function of a part of the components of the device in the above-described embodiments (the generation device 10, the optimization device 20, the execution device 30, and the terminal device 40). That is, the computer 7 may transmit a part or all of the processing result to the external device 9A or the external device 9B, or may receive a part or all of the processing result from the external device 9A or the external device 9B.

In the present specification (including the claims), if the expression “at least one of a, b, and c” or “at least one of a, b, or c” is used (including similar expressions), any one of a, b, c, a-b, a-c, b-c, or a-b-c is included. Multiple instances may also be included in any of the elements, such as a-a, a-b-b, and a-a-b-b-c-c. Further, the addition of another element other than the listed elements (i.e., a, b, and c), such as adding d as a-b-c-d, is included.

In the present specification (including the claims), if the expression such as “in response to data being input”, “using data”, “based on data”, “according to data”, or “in accordance with data” (including similar expressions) is used, unless otherwise noted, a case in which the data itself is used and a case in which data obtained by processing the data (e.g., data obtained by adding noise, normalized data, a feature amount extracted from the data, and intermediate representation of the data) is used are included. If it is described that any result can be obtained “in response to data being input”, “using data”, “based on data”, “according to data”, or “in accordance with data” (including similar expressions), unless otherwise noted, a case in which the result is obtained based on only the data is included, and a case in which the result is obtained affected by another data other than the data, factors, conditions, and/or states may be included. If it is described that “data is output” (including similar expressions), unless otherwise noted, a case in which the data itself is used as an output is included, and a case in which data obtained by processing the data in some way (e.g., data obtained by adding noise, normalized data, a feature amount extracted from the data, and intermediate representation of the data) is used as an output is included.

In the present specification (including the claims), if the terms “connected” and “coupled” are used, the terms are intended as non-limiting terms that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the terms without being limited.

In the present specification (including the claims), if the expression “A configured to B” is used, a case in which a physical structure of the element A has a configuration that can perform the operation B, and a permanent or temporary setting/configuration of the element A is configured/set to actually perform the operation B may be included. For example, if the element A is a general purpose processor, the processor may have a hardware configuration that can perform the operation B and be configured to actually perform the operation B by setting a permanent or temporary program (i.e., an instruction). If the element A is a dedicated processor, a dedicated arithmetic circuit, or the like, a circuit structure of the processor may be implemented so as to actually perform the operation B irrespective of whether the control instruction and the data are actually attached.

In the present specification (including the claims), if a term indicating inclusion or possession (e.g., “comprising”, “including”, or “having”) is used, the term is intended as an open-ended term, including inclusion or possession of an object other than a target object indicated by the object of the term. If the object of the term indicating inclusion or possession is an expression that does not specify a quantity or that suggests a singular number (i.e., an expression using “a” or “an” as an article), the expression should be interpreted as being not limited to a specified number.

In the present specification (including the claims), even if an expression such as “one or more” or “at least one” is used in a certain description, and an expression that does not specify a quantity or that suggests a singular number (i.e., an expression using “a” or “an” as an article) is used in another description, it is not intended that the latter expression indicates “one”. Generally, an expression that does not specify a quantity or that suggests a singular number (i.e., an expression using “a” or “an” as an article) should be interpreted as being not necessarily limited to a particular number.

In the present specification, if it is described that a particular advantage/result is obtained in a particular configuration included in an embodiment, unless there is a particular reason, it should be understood that that the advantage/result may be obtained in another embodiment or other embodiments including the configuration. It should be understood, however, that the presence or absence of the advantage/result generally depends on various factors, conditions, and/or states, and that the advantage/result is not necessarily obtained by the configuration. The advantage/result is merely an advantage/result that is obtained by the configuration described in the embodiment when various factors, conditions, and/or states are satisfied, and is not necessarily obtained in the invention according to the claim that defines the configuration or a similar configuration.

In the present specification (including the claims), if multiple hardware performs predetermined processes, each of the hardware may cooperate to perform the predetermined processes, or some of the hardware may perform all of the predetermined processes. Additionally, some of the hardware may perform some of the predetermined processes while other hardware may perform the remainder of the predetermined processes. In the present specification (including the claims), if an expression such as “one or more hardware perform a first process and the one or more hardware perform a second process” is used, the hardware that performs the first process may be the same as or different from the hardware that performs the second process. That is, the hardware that performs the first process and the hardware that performs the second process may be included in the one or more hardware. The hardware may include an electronic circuit, a device including an electronic circuit, or the like.

In the present specification (including the claims), if multiple storage devices (memories) store data, each of the multiple storage devices (memories) may store only a portion of the data or may store an entirety of the data. Additionally, a configuration in which some of the multiple storage devices store data may be included.

In the present specification (including the claims), the terms “first,” “second,” and the like are used as a method of merely distinguishing between two or more elements and are not necessarily intended to impose technical significance on their objects, in a temporal manner, in a spatial manner, in order, in quantity, or the like. Therefore, for example, a reference to first and second elements does not necessarily indicate that only two elements can be employed there, that the first element must precede the second element, that the first element must be present in order for the second element to be present, or the like.

Although the embodiments of the present disclosure have been described in detail above, the present disclosure is not limited to the individual embodiments described above. Various additions, modifications, substitutions, partial deletions, and the like can be made without departing from the conceptual idea and spirit of the invention derived from the contents defined in the claims and the equivalents thereof. For example, in the embodiments described above, if numerical values or mathematical expressions are used for description, they are presented as an example and do not limit the scope of the present disclosure. Additionally, the order of respective operations in the embodiments is presented as an example and does not limit the scope of the present disclosure.

What is claimed is:

1. An information processing device comprising:
one or more processors; and
one or more memories storing instructions that, when executed by the one or more processors, cause the one or more processors to:
obtain one or more evaluation results of one or more first templates, the one or more first templates being used for generating one or more pieces of first input information to a first generative model;
generate second input information to a second generative model based on the one or more evaluation results; and
obtain a second template generated by inputting the second input information into the second generative model,
wherein the second input information includes at least:
one or more pieces of template information obtained based on the one or more evaluation results; and
information related to one or more placeholders.

2. The information processing device as claimed in claim 1, wherein the one or more first templates include the one or more placeholders, and the second template includes the one or more placeholders.

3. The information processing device as claimed in claim 1, wherein the second input information includes:
information instructing the generation of the second template based on the one or more pieces of template information; and
a constraint related to the second template.

4. The information processing device as claimed in claim 1, wherein the one or more placeholders include a placeholder indicating a position of a soft prompt.

5. The information processing device as claimed in claim 1,
wherein the one or more first templates include a placeholder indicating a position of a soft prompt, and
wherein the instructions, when executed by the one or more processors, further cause the one or more processors to optimize the soft prompt.

6. The information processing device as claimed in claim 1, wherein the instructions, when executed by the one or more processors, further cause the one or more processors to, until a predetermined condition is satisfied, repeatedly perform:
obtaining an evaluation result of the second template;
generating the second input information based on the one or more evaluation results including the evaluation result of the second template; and
obtaining the second template.

7. The information processing device as claimed in claim 1, wherein the second input information includes information specifying at least one of a type of a markup language, a type of a symbol, an order of contents, or a repetition of an item.

8. The information processing device as claimed in claim 1, wherein the instructions, when executed by the one or more processors, cause the one or more processors to generate the second input information by an optimization algorithm using the one or more evaluation results.

9. The information processing device as claimed in claim 8, wherein the optimization algorithm includes at least one of a genetic algorithm, a Bayesian optimization, an evolution strategy, or a reinforcement learning.

10. The information processing device as claimed in claim 1, wherein the instructions, when executed by the one or more processors, further cause the one or more processors to obtain the one or more pieces of template information including one or more templates among the one or more first templates, each of the one or more templates having an evaluation value higher than an evaluation value of another first template among the one or more first templates, the evaluation value indicating one of the one or more evaluation results.

11. The information processing device as claimed in claim 1, wherein the instructions, when executed by the one or more processors, further cause the one or more processors to obtain the one or more pieces of template information from the one or more first templates based on the one or more evaluation results.

12. The information processing device as claimed in claim 1, wherein the instructions, when executed by the one or more processors, further cause the one or more processors to obtain, as the one or more pieces of template information, a predetermined number of first templates having high evaluation values from the one or more first templates.

13. The information processing device as claimed in claim 12, wherein the predetermined number of first templates are selected by using history information of evaluation results.

14. The information processing device as claimed in claim 1, wherein the instructions, when executed by the one or more processors, further cause the one or more processors to update parameters of the second generative model by reinforcement learning using the second input information as an action and an evaluation result of the second template as a reward.

15. The information processing device as claimed in claim 1, wherein the instructions, when executed by the one or more processors, further cause the one or more processors to:
generate the one or more pieces of first input information by using the one or more first templates;
obtain one or more output results generated by inputting the one or more pieces of first input information into the first generative model; and
obtain the one or more evaluation results based on the one or more output results.

16. The information processing device as claimed in claim 15, wherein the one or more pieces of first input information are input information for performing one or more tasks of answering one or more questions, and the one or more evaluation results are information indicating one or more correct answer rates of the one or more output results.

17. The information processing device as claimed in claim 15, wherein the instructions, when executed by the one or more processors, further cause the one or more processors to:
present the one or more output results to one or more users; and
obtain the one or more evaluation results based on feedback information obtained from the one or more users.

18. The information processing device as claimed in claim 15, wherein the instructions, when executed by the one or more processors, cause the one or more processors to generate the second input information based on feedback information for the one or more output results.

19. The information processing device as claimed in claim 1,
wherein the instructions, when executed by the one or more processors, further cause the one or more processors to generate the one or more first templates by inputting one or more pieces of third input information into a third generative model, and
wherein the one or more pieces of third input information include the information related to the one or more placeholders.

20. The information processing device as claimed in claim 1, wherein the instructions, when executed by the one or more processors, further cause the one or more processors to:
obtain the one or more pieces of template information by using one or more templates among the one or more first templates, each of the one or more templates having an evaluation value lower than an evaluation value of another first template among the one or more first templates, the evaluation value indicating one of the one or more evaluation results, and
generate a data set to be used for additional learning of the first generative model by using the second template.

21. The information processing device as claimed in claim 20, wherein the instructions, when executed by the one or more processors, further cause the one or more processors to perform additional learning on the first generative model by using the data set.

22. The information processing device as claimed in claim 1, wherein the first generative model and the second generative model are the same generative model.

23. The information processing device as claimed in claim 1, wherein the one or more pieces of template information include at least more than two of the one or more first templates or information generated based on more than two of the one or more first templates.

24. The information processing device as claimed in claim 23, wherein the second input information includes evaluation results corresponding to the more than two of the one or more first templates.

25. The information processing device as claimed in claim 1, wherein the one or more evaluation results include different types of evaluation values.

26. An information processing method comprising:
obtaining, by one or more processors, one or more evaluation results of one or more first templates, the one or more first templates being used for generating one or more pieces of first input information to a first generative model;
generating, by the one or more processors, second input information to a second generative model based on the one or more evaluation results; and
obtaining, by the one or more processors, a second template generated by inputting the second input information into the second generative model,
wherein the second input information includes at least:
one or more pieces of template information obtained based on the one or more evaluation results; and
information related to one or more placeholders.

27. A non-transitory computer-readable recording medium having stored therein one or more programs for causing one or more processors to perform a process comprising:
obtaining one or more evaluation results of one or more first templates, the one or more first templates being used for generating one or more pieces of first input information to a first generative model;
generating second input information to a second generative model based on the one or more evaluation results; and
obtaining a second template generated by inputting the second input information into the second generative model,
wherein the second input information includes at least:
one or more pieces of template information obtained based on the one or more evaluation results; and
information related to one or more placeholders.

28. An information processing system comprising:
a terminal device; and
an information processing device configured to:
obtain one or more evaluation results of one or more first templates, the one or more first templates being used for generating one or more pieces of first input information to a first generative model;
generate second input information to a second generative model based on the one or more evaluation results; and
obtain a second template generated by inputting the second input information into the second generative model,
wherein the second input information includes at least:
one or more pieces of template information obtained based on the one or more evaluation results; and
information related to one or more placeholders, and
wherein the information processing device is configured to obtain the second template based on a request from the terminal device.
